(19) United States
(12) Patent Application Publication
(10) Pub. No.: US 2017/0075955 A1
(43) Pub. Date: Mar. 16, 2017

(54) DATABASE SYSTEM, DATABASE ACCESS METHOD, AND DATABASE ACCESS PROGRAM

(71) Applicant: FUJITSU LIMITED, Kawasaki-shi (JP)

(72) Inventors: Norihisa Yuyama, Odawara (JP); Yasuhiro Suzuki, Yokohama (JP); Naoki Nakatogawa, Kawasaki (JP); Hisaya Fujii, Numazu (JP); Yoshihiro Tsujikawa, Kobe (JP); Shuji SEKIYA, Chigasaki (JP)

(73) Assignee: FUJITSU LIMITED, Kawasaki-shi (JP)

(21) Appl. No.: 15/248,133

(22) Filed: Aug. 26, 2016

(30) Foreign Application Priority Data
Sep. 16, 2015 (JP) 2015-183154

(51) Int. Cl. G06F 17/30

(52) U.S. Cl. CPC G06F 17/30463; G06F 17/30578; G06F 17/30595

(57) ABSTRACT

A database system includes a first information processing device that accesses a first database, and a second information processing device that accesses a second database that is a standby system of the first database, wherein the first information processing device includes a processor that executes a process including transmitting to the second information processing device a query corresponding to regeneration target execution plan information among items of execution plan information for access to the first database, and the second information processing device includes a processor that executes a process including updating first information indicating characteristics of the second database in response to updating of data of the second database, regenerating the regeneration target execution plan information, based on the first information and the query, and transmitting the regenerated execution plan information to the first information processing device.

### CROSS-REFERENCE TO RELATED APPLICATION

This application is based upon and claims the benefit of priority of the prior Japanese Patent Application No. 2015-183154, filed on Sep. 16, 2015, the entire contents of which are incorporated herein by reference.

### FIELD

The present invention relates to a database system, a database access method, and a database access program.

### BACKGROUND

A database system that manages databases storing data is known. The database system receives a query (structured query language (SQL) command) from a client and selects an access path (execution plan information, also referred to as an access plan) to a database which is most efficient for executing the SQL command. Moreover, the database system executes the SQL command according to the access plan to realize access to the database.

The time needed for processing the SQL command changes depending on the access plan. The database system generates an access path which minimizes the processing time among a plurality of access path candidates as an access plan based on characteristic information (also referred to as optimization information) of the database. A technique related to generation of the access plan is disclosed in Japanese Laid-open Patent Publication No. 2003-316811, for example.

### SUMMARY

According to an aspect of the embodiments, a database system includes a first information processing device that accesses a first database, and a second information processing device that accesses a second database that is a standby system of the first database, wherein the first information processing device includes a processor that executes a process including transmitting to the second information processing device a query corresponding to regeneration target execution plan information among items of execution plan information for access to the first database, and the second information processing device includes a processor that executes a process including updating first information indicating characteristics of the second database in response to updating of data of the second database, regenerating the regeneration target execution plan information, based on the first information and the query, and transmitting the regenerated execution plan information to the first information processing device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a configuration of a database system according to the present embodiment;

FIG. 2 is a diagram schematically illustrating the flow of the process of the mirroring system according to a comparative example;

FIG. 3 is a diagram illustrating an example of the access plan AP;

FIG. 4 is a diagram for describing the flow of a process from generation to cancellation of the access plan AP;

FIG. 5 is a flowchart for describing the flow of a process of the database system according to the present embodiment;

FIG. 6 is a diagram illustrating an example of an access plan APr regenerated by the auxiliary database server 100 of the present embodiment;

FIG. 7 is a diagram illustrating the processing time when a SQL command sq was executed according to the access plan AP (FIG. 3) generated by the primary DB access program;

FIG. 8 is a diagram illustrating the processing time when a SQL command sq was executed according to the access plan APr (FIG. 6) regenerated by the auxiliary DB access program;

FIG. 9 is a hardware configuration diagram of the primary database server (the first information processing device) 200 of the present embodiment;

FIG. 10 is a configuration diagram of a software block of the primary database server 200 illustrated in FIG. 9;

FIG. 11 is a hardware configuration diagram of the auxiliary database server (the second information processing device) 100 of the present embodiment;

FIG. 12 is a configuration diagram of a software block of the auxiliary database server 100 illustrated in FIG. 11;

FIG. 13 is a diagram for schematically describing the details of the processes of the DB access program 220 of the primary database server 200 and the DB access program 120 of the auxiliary database server 100 according to the present embodiment;

FIG. 14 is a diagram illustrating an example of the optimization information 231 of the primary database server 200;

FIG. 15 is a diagram illustrating an example of the updated optimization information 131r;

FIG. 16 is a diagram for describing the flow of a process of the primary DB access program 220 instructing regeneration of the access plan AP;

FIG. 17 is a diagram for describing the flow of a process of the primary DB access program 220 receiving the access plan AP regenerated by the auxiliary access program;

FIG. 18 is a flowchart for describing a process of the auxiliary DB access program 120 regenerating the access plan AP;

FIG. 19 is a flowchart for describing the details of the process of step S48 in the flowchart of FIG. 18;

FIG. 20 is a flowchart for describing the flow of the process of step S43 in the flowchart of FIG. 18;

FIG. 21 is a diagram for describing the priority order of a SQL command sq that regenerates an access plan AP; and

FIG. 22 is a flowchart for describing the details of the process of step S52 in the flowchart of FIG. 19.

### DESCRIPTION OF EMBODIMENTS

However, since the database system scans records of a database to update the optimization information, the load of the updating process increases when there are an enormous number of records in the database. Due to this, when the database system updates the optimization information in a business hour in which business processes are performed, the business processes may be delayed.

Thus, an administrator updates the optimization information in a period in which a maintenance process is performed after the business hour rather than updating the optimization information in the business hour, for example. However, since the optimization information is not updated in the business hour, the optimization information may be different from the actual database state. Since the optimization information is not based on the actual database state, the database system may sometimes be unable to generate an optimal access plan.

[Database System]

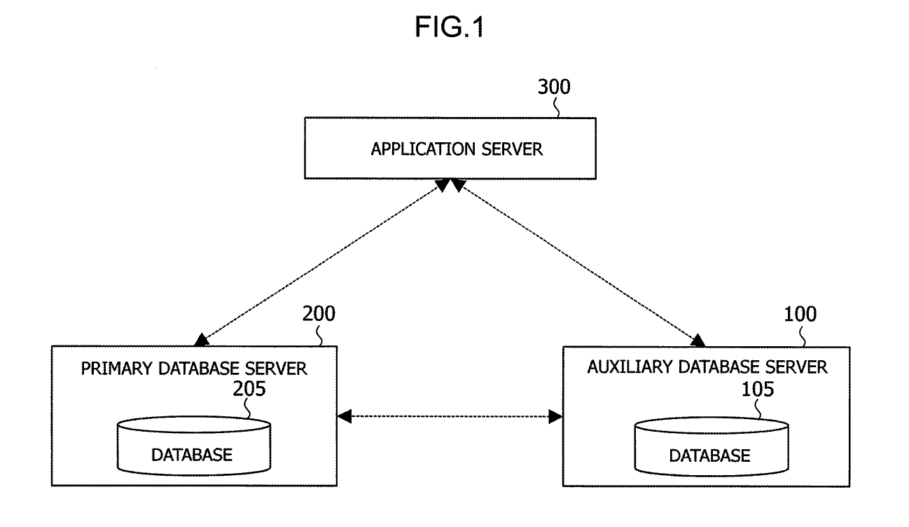

FIG. 1 is a diagram for describing a configuration of a database system according to the present embodiment. The database system illustrated in FIG. 1 includes a primary database server 200, an auxiliary database server 100, and an application server 300. The primary database server 200, the auxiliary database server 100, and the application server 300 are connected to each other. Moreover, the primary and auxiliary database servers 100 and 200 have databases 105 and 205, respectively.

The database system illustrated in FIG. 1 is a mirroring system. The mirroring system is a system that includes hardware and software and has dual database servers that operate for business. The auxiliary database server 100 is a standby server of the primary database server 200.

That is, the hardware of the auxiliary database server 100 has the same specification as the hardware of the primary database server 200. Moreover, the database (also referred to as an auxiliary database 105) of the auxiliary database server 100 has the same information as the database (also referred to as a primary database 205) of the primary database server 200.

Moreover, the primary and auxiliary databases 105 and 205 in FIG. 1 are relational databases, for example. Each of the databases 105 and 205 has a plurality of tables for storing data and indices for storing index information indicating the data stored in the tables.

The application server 300 illustrated in FIG. 1 executes an application to perform a business process. When accessing the primary database 205, the application server 300 transmits a structured query language (SQL) command to the primary database server 200. The SQL command (query) is a database language (query language) indicating a data access to a database and definition of a database.

In response to reception of the SQL command, the primary database server 200 performs access to the database 205. The access involves retrieval (SELECT), adding (INSERT), deletion (DELETE), updating (UPDATE), and the like of data, for example.

Moreover, in response to updating of the database 205, the primary database server 200 generates update difference data 141 including updated information and transmits the same to the auxiliary database server 100. The auxiliary database server 100 updates the database 105 according to the received update difference data 141.

In this manner, the mirroring system applies the data updated by the primary database server 200 in response to the request from the application server 300 to the auxiliary database 105 one by one. In this way, the auxiliary database 105 holds the same information as the primary database 205.

### COMPARATIVE EXAMPLE

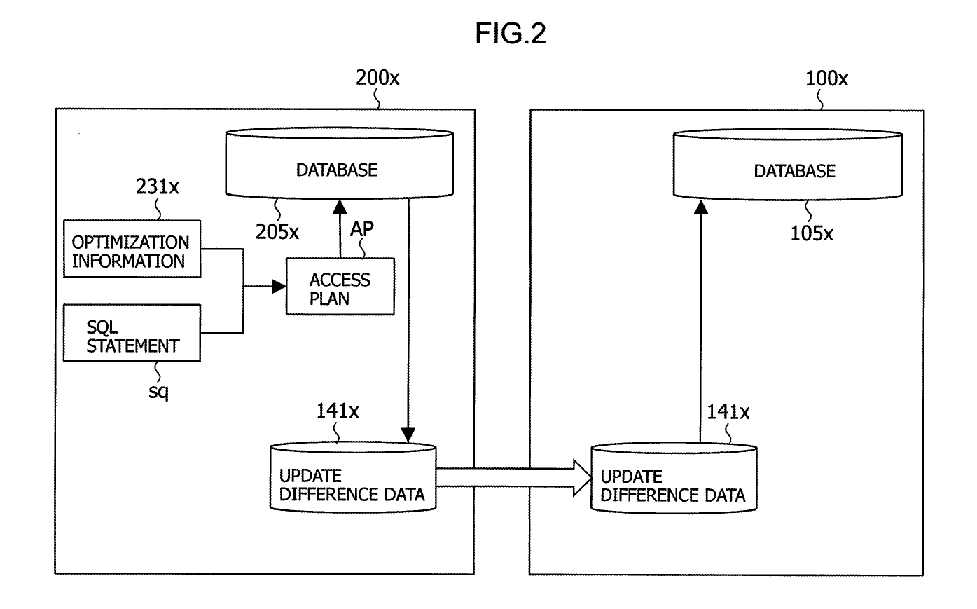

FIG. 2 is a diagram schematically illustrating the flow of the process of the mirroring system according to a comparative example. FIG. 2 illustrates a primary database server 200x and an auxiliary database server 100x. Database (DB) access programs (not illustrated in FIG. 2) for performing a series of processes (management processes) for databases 105x and 205x operate in the primary and auxiliary database servers 100x and 200x, respectively.

The DB access program of the primary database server 200x generates an access plan AP based on an execution target SQL command sq and optimization information 231x in response to a request of an application server. The optimization information 231x is information indicating the characteristics of a group of records stored in the database 205x.

The access plan AP indicates an optimal access path to databases when executing a SQL command sq. The access path is a plan indicating, for instance, which tables or indices are to be accessed and in which order the tables or indices are to be accessed to execute the SQL command sq. The optimal access path is an access path which minimizes the processing time (response time) of the SQL command sq.

The primary DB access program executes a SQL command sq according to the access plan AP to perform access to the database 205x. The primary DB access program generates update difference data 141x based on update information of the database 205x and transmits the same to the auxiliary database server 100x.

The DB access program of the auxiliary database server 100x updates the database 105x based on the received update difference data 141x. In this way, the auxiliary database 105x holds the same content as the primary database 205x.

[Access Plan AP]

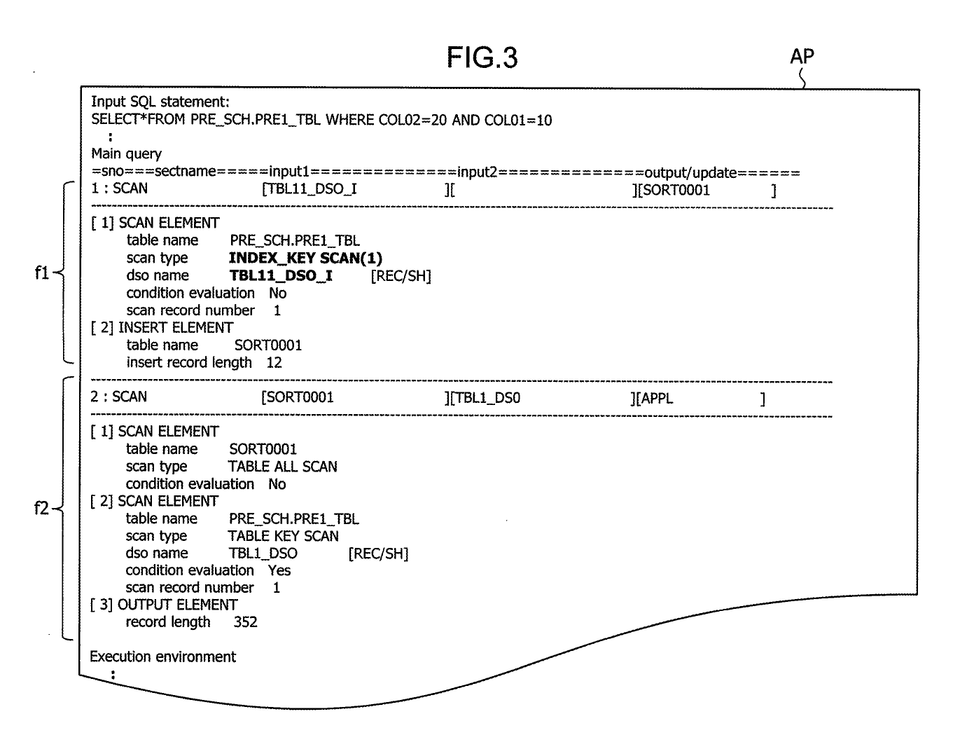

FIG. 3 is a diagram illustrating an example of the access plan AP. The access plan AP illustrated in FIG. 3 indicates the plan of an access path when executing a SQL command sq “SELECT*FROM PRE_SCH.PRE1_TBL WHERE COL02=20 AND COL01=10”.

The databases 105 and 205 of the present embodiment have a table “PRE1_TBL” having the items “COL01” and “COL02”. Moreover, the databases have an index “TBL11_DSO_I” having the item “COL01” as a key and an index “TBL12_DSO_I” having the item “COL02” as a key.

The SQL command sq “SELECT*FROM PRE_SCH.PRE1_TBL WHERE COL02=20 AND COL01=10” is a query that indicates retrieval of a record of which the item “COL02” has a value of “20” and the item “COL01” has a value of “10” from the table “PRE1_TBL”.

The access plan AP illustrated in FIG. 3 indicates a plan to access the index “TBL11_DSO_I” to execute the SQL command sq. Specifically, the access plan AP has a first step f1 of accessing the index “TBL11_DSO_I” to extract a record of which the item “COL01” has a value of “10” and a second step f2 of extracting a record of which the item “COL02” has a value of “20” based on the extraction result.

More specifically, the first step f1 indicates a step of accessing the index “TBL11_DSO_I” to extract a record of which the item “COL01” has a value of “10” and insert the record into a table “SORT0001”. The second step f2 indicates a step of scanning the tables “SORT0001” and “PRE1_TBL” to extract a record of which the item “COL02” has a value of “20”.

[From Generation to Cancellation of Access Plan AP]

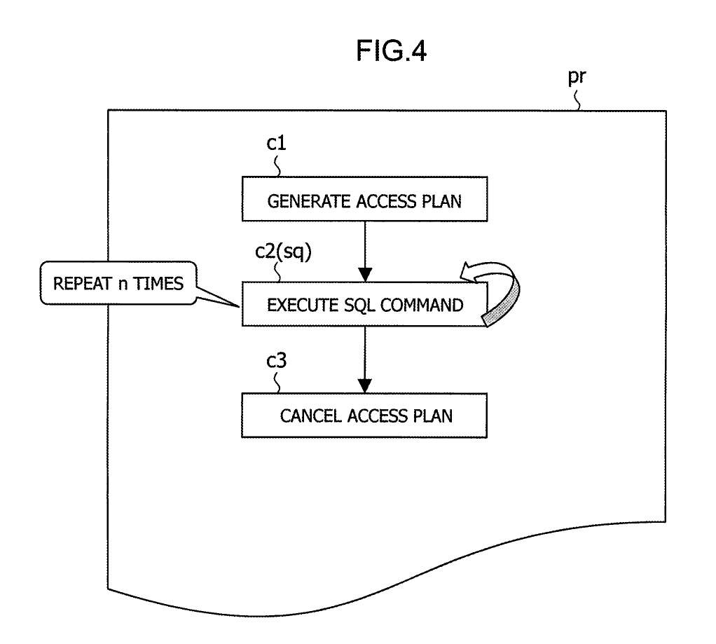

FIG. 4 is a diagram for describing the flow of a process from generation to cancellation of the access plan AP. FIG. 4 illustrates an example of a program pr that operates on the application server 300. The application program pr realizes access to a database (for example, the database 205 in FIG. 1) by calling a SQL command sq.

The program pr has a statement (SQL statement) that indicates a series of processes of generating an access plan AP of a SQL command sq to execute the SQL command sq according to the access plan AP and cancelling the access plan AP.

Specifically, as illustrated in FIG. 4, the program pr has a SQL statement c1 that indicates generation of an access plan AP of the SQL command sq before the SQL command sq that indicates access. Moreover, the program pr has a SQL statement c2 that indicates execution of the SQL command sq based on the generated access plan AP and a SQL statement c3 that indicates cancellation of the access plan AP. The SQL statement c2 includes an indication of the number of executions (n times) of the access.

[Updating of Optimization Information]

The DB access program updates the optimization information according to a command or the like that indicates updating of the optimization information, input arbitrarily, for example. The optimization information is information indicating the characteristics of a database. The optimization information indicates the number (hereinafter also referred to as a type count) of value types of the index, the number of records of the table, and the like, for example.

The DB access program updates the optimization information by scanning a group of records stored in the database. Thus, when there are an enormous number of records, the load of the optimization information updating process is high and the time needed for the optimization information updating process also increases.

Therefore, when the optimization information updating process is performed in a period (hereinafter also referred to as a business hour) in which business processes are performed, the load of the DB access program may increase, the response time of the access process may increase, and the business processes may be delayed. Due to this, an administrator issues an instruction to perform the optimization information updating process in a maintenance period, a night hour where a small number of business processes are performed, or other periods after the business hour, for example.

However, since the records of a database are likely to change greatly in the business hour, the optimization information may change greatly in the business hour. Since the optimization information is not updated in the business hour, the optimization information is different from the actual database state. That is, a state in which the optimization information is not synchronized with the actual database state may occur.

As described with reference to FIG. 2, the DB access program generates an access plan AP of a SQL command sq based on optimization information. Since the access plan AP is based on the optimization information which is not synchronized with the actual database state, it may sometimes be unable to generate an optimal access plan AP. In order to generate an optimal access plan AP, it is preferable to generate the access plan AP based on optimization information which is based on the database state.

### Outline of Present Embodiment

The database system of the present embodiment includes a first information processing device that accesses a first database and a second information processing device that accesses a second database which is a standby system of the first database.

The first information processing device includes a first transmitter that transmits a query corresponding to execution plan information to be regenerated among items of execution plan information for access to the first database to the second information processing device.

The second information processing device includes an update processor that updates first information indicating the characteristics of the second information in response to updating of the data of the second database. Moreover, the second information processing device includes a generation processor that regenerates the execution plan information to be regenerated based on the first information and the query and a second transmitter that transmits the regenerated execution plan information to the first information processing device.

In this way, the second information processing device can regenerate optimal execution plan information based on the first information updated in response to updating of the data of the second database. Moreover, the first information processing device can shorten the query processing time by executing the query according to the optimal execution plan information. Moreover, the first information processing device can suppress an increase in the computer processing load and avoid the occurrence of a delay in the business processes since the first information is not updated.

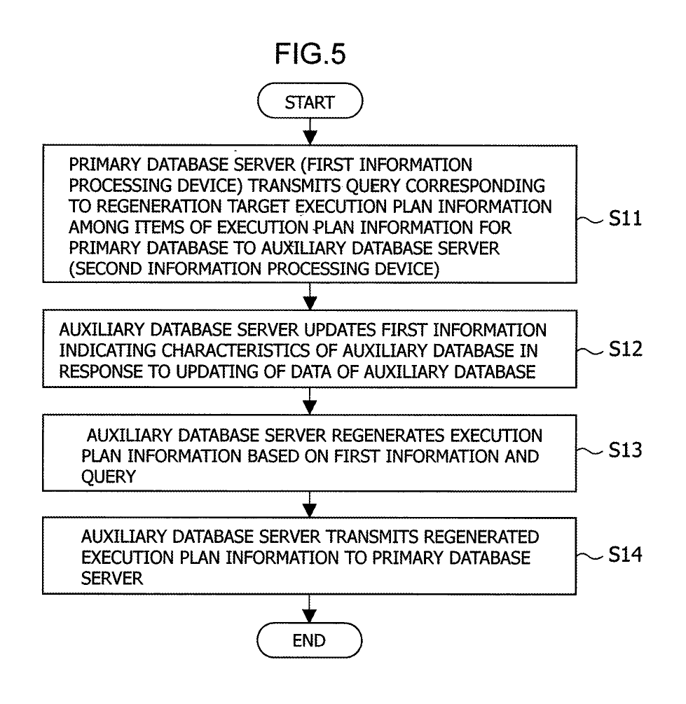

FIG. 5 is a flowchart for describing the flow of a process of the database system according to the present embodiment. The first information processing device corresponds to the primary database server 200 (FIG. 1) and the second information processing device corresponds to the auxiliary database server 100 (FIG. 1). Moreover, the first database corresponds to the primary database 205 (FIG. 1) and the second database corresponds to the auxiliary database 105 (FIG. 1).

In step S11, the primary database server 200 transmits a query (SQL command sq) corresponding to execution plan information to be regenerated among items of execution plan information (access plans AP) for the primary database 205 to the auxiliary database server 100.

The primary database server 200 executes a plurality of SQL commands sq in parallel, for example. For example, the primary database server 200 transmits a SQL command sq that indicates, for example, updating or retrieval of an access plan AP which can provide an effect when the access plan AP is regenerated among items of access plans AP of a SQL command sq in execution to the auxiliary database server 100.

In step S12, the auxiliary database server 100 updates first information (optimization information) indicating the characteristics of the auxiliary database 105 in response to updating of the data of the auxiliary database 105. As described above, the first information (optimization information) indicates any one or both of the number (type count) of value types of a predetermined item and the number of records of the auxiliary database 105.

In step S13, the auxiliary database server 100 regenerates the execution plan information (access plan AP) based on the first information (optimization information) and the query (SQL command sq). That is, the auxiliary database server 100 generates the access plan AP based on the SQL command sq received from the primary database 205 and the optimization information updated to the latest state. In this way, the auxiliary database server 100 can generate the optimal access plan AP based on the optimization information that is based on the actual state of the database 105.

In step S14, the auxiliary database server 100 transmits the regenerated execution plan information (access plan AP) to the primary database server 200. As described with reference to FIG. 4, there is a SQL command sq which is executed a plurality of number of (n) times. When the SQL command sq has not been executed n times, the primary DB access program replaces the access plan AP of the SQL command sq with the access plan AP regenerated by the auxiliary DB access program.

In this way, the primary database server 200 can execute the SQL command sq according to the access plan AP based on the optimization information indicating the latest characteristics of the database 205. As a result, the processing time of the SQL command sq is reduced and the performance of the access to the database 205 is improved. Moreover, the primary database server 200 can generate such an access plan AP that the computer processing load is suppressed since the optimization information is not updated to regenerate the access plan AP.

[Regenerated Access Plan]

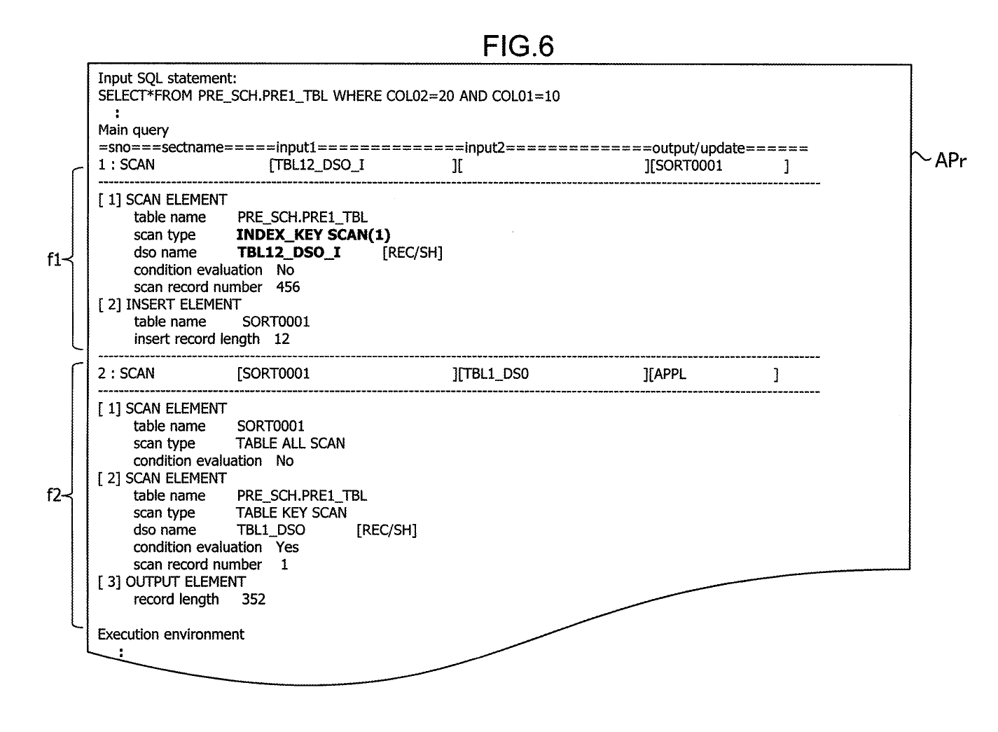

FIG. 6 is a diagram illustrating an example of an access plan APr regenerated by the auxiliary database server 100 of the present embodiment. The access plan APr illustrated in FIG. 6 is an access plan corresponding to the same SQL command sq as the access plan AP illustrated in FIG. 3. The SQL command sq is as illustrated in FIG. 3.

The access plan APr illustrated in FIG. 6 is an access plan based on the optimization information which is updated to a latest state. In the present embodiment, a case in which the result of access to the database 105 exhibits that the number of value types of the index “TBL12_DSO_I” is larger than that of the index “TBL11_DSO_I” is illustrated. That is, a case in which the result of the access exhibits that the number of value types of the item “COL02” is larger than the number of value types of the item “COL01” is illustrated.

The access plan APr illustrated in FIG. 6 indicates a plan to access the index “TBL12_DSO_I” to execute a SQL command sq. Specifically, the access plan APr includes a first step f11 of accessing the index “TBL12_DSO_I” to extract a record of which the item “COL02” has a value of “20” and a second step f12 of extracting a record of which the item “COL01” has a value of “10” based on the extraction result.

More specifically, the first step f11 indicates a step of accessing the index “TBL12_DSO_I” to extract a record of which the item “COL02” has a value of “20” and insert the record into a table “SORT0001”. The second step f12 indicates a step of scanning the tables “SORT0001” and “PRE1_TBL” to extract a record of which the item “COL01” has a value of “10”.

As described above, in the present embodiment, the number of value types of the index “TBL12_DSO_I” is larger than that of the index “TBL11_DSO_I”. Due to this, it is possible to narrow down the records extracted in the first step more effectively by accessing the index “TBL12_DSO_I”. Since the number of records extracted in the first step is small, it is possible to reduce the processing time. Moreover, since the number of records extracted in the first step, which are referred to in the second step, it is possible to reduce the processing time of the second step.

Thus, according to the access plan APr illustrated in FIG. 6, it is possible to perform the access (SELECT) more efficiently by accessing the index “TBL12_DSO_I”. That is, since the access plan APr is generated based on the optimization information which reflects the actual state of the database 105, it is possible to generate an optimal access plan APr which is based on the characteristics of the database 105.

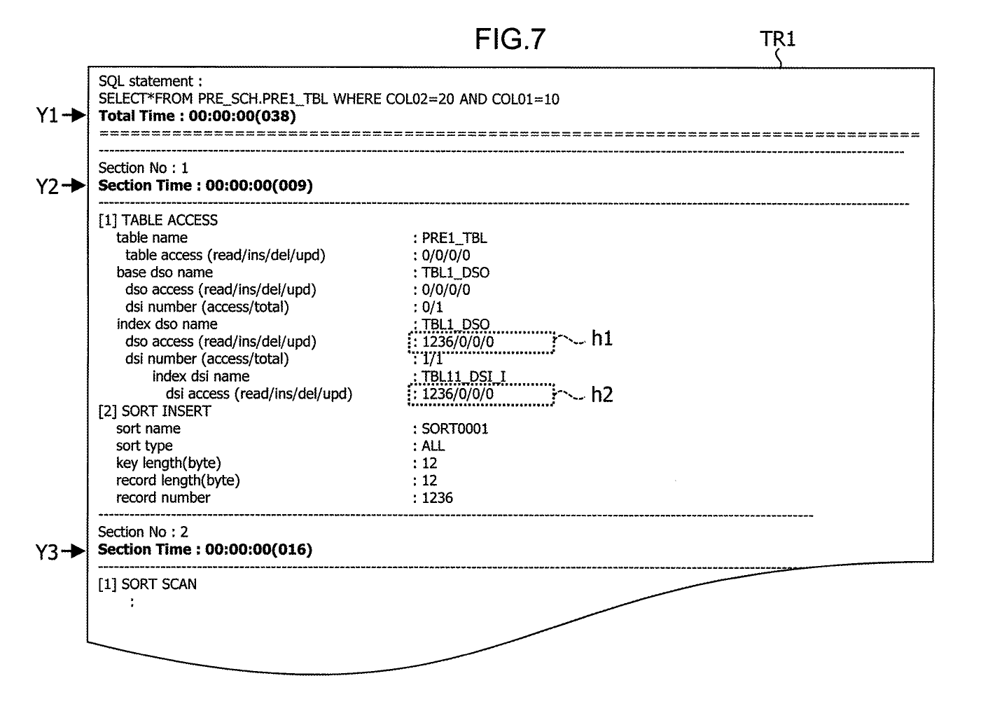

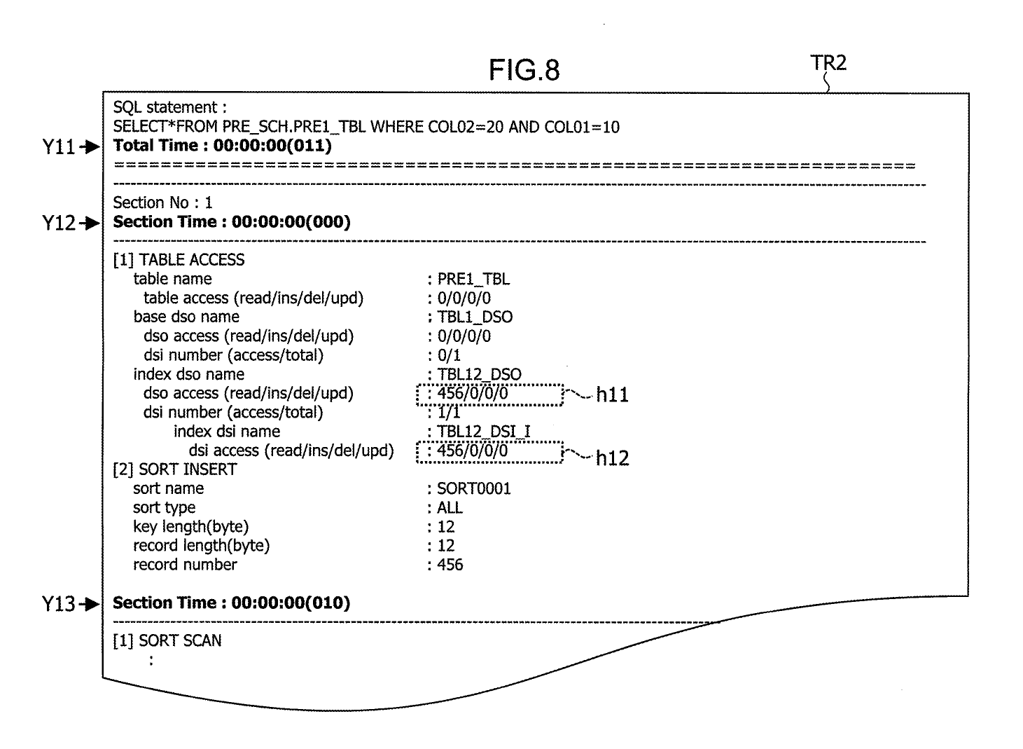

Next, an example of a reduction in the processing time (cost) by execution of the SQL command sq according to the access plan AP illustrated in FIGS. 3 and 6 will be described with reference to FIGS. 7 and 8.

[Processing Time]

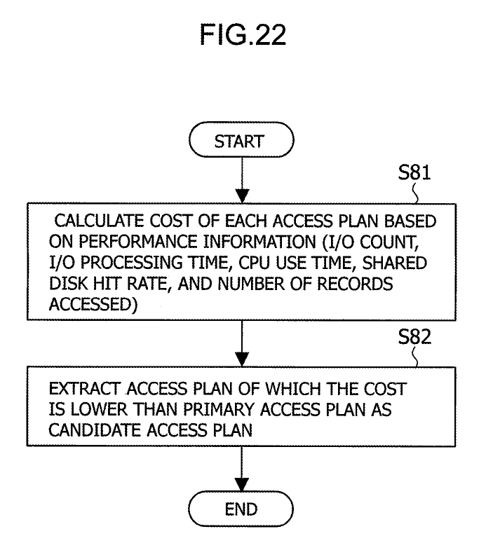

FIG. 7 is a diagram illustrating the processing time when a SQL command sq was executed according to the access plan AP (FIG. 3) generated by the primary DB access program. FIG. 7 illustrates trace information TR1 of the SQL command sq, having processing time and access history. Information h1 and h2 will be described later with reference to FIG. 22.

Arrow Y1 illustrated in FIG. 7 indicates the processing time “038 ms” taken until processing of a SQL command sq “SELECT*FROM PRE_SCH.PRE1_TBL WHERE COL02=20 AND COL01=10” is completed. The processing time “009 ms” indicated by arrow Y2 and the processing time “016 ms” indicated by arrow Y3 indicate the section time of the processing time “038 ms”.

Specifically, the processing time “009 ms” indicated by arrow Y2 indicates the processing time of the first step (f1 in FIG. 3) of extracting a record of which the item “COL01” has a value of “10” from the index “TBL11_DSO_I”. Moreover, the processing time “016 ms” indicated by arrow Y3 indicates the processing time of the second step (f2 in FIG. 3) of extracting a record of which the item “COL02” has a value of “20” based on the extraction result.

FIG. 8 is a diagram illustrating the processing time when a SQL command sq was executed according to the access plan APr (FIG. 6) regenerated by the auxiliary DB access program. FIG. 8 illustrates trace information TR2 of a SQL command sq, having processing time and access history. Information h11 and h12 will be described later with reference to FIG. 22.

Arrow Y11 illustrated in FIG. 8 indicates the processing time “011 ms” taken until processing of a SQL command sq “SELECT*FROM PRE_SCH.PRE1_TBL WHERE COL02=20 AND COL01=10” is completed. Moreover, the processing time “000 ms” indicated by arrow Y12 and the processing time “010 ms” indicated by arrow Y13 indicate the section time of the processing time “011 ms”.

Specifically, the processing time “000 ms” indicated by arrow Y12 indicates the processing time of the first step (f11 in FIG. 6) of extracting a record of which the item “COL02” has a value of “20” from the index “TBL12_DSO_I”.

Moreover, the processing time “010 ms” indicated by arrow Y13 indicates the processing time of the second step (f12 in FIG. 6) of extracting a record of which the item “COL01” has a value of “10” based on the extraction result.

As illustrated in FIGS. 7 and 8, since the SQL command sq is executed according to the access plan APr regenerated by the auxiliary DB access program, the processing time of the SQL command sq is reduced from “038 ms” to “011 ms”.

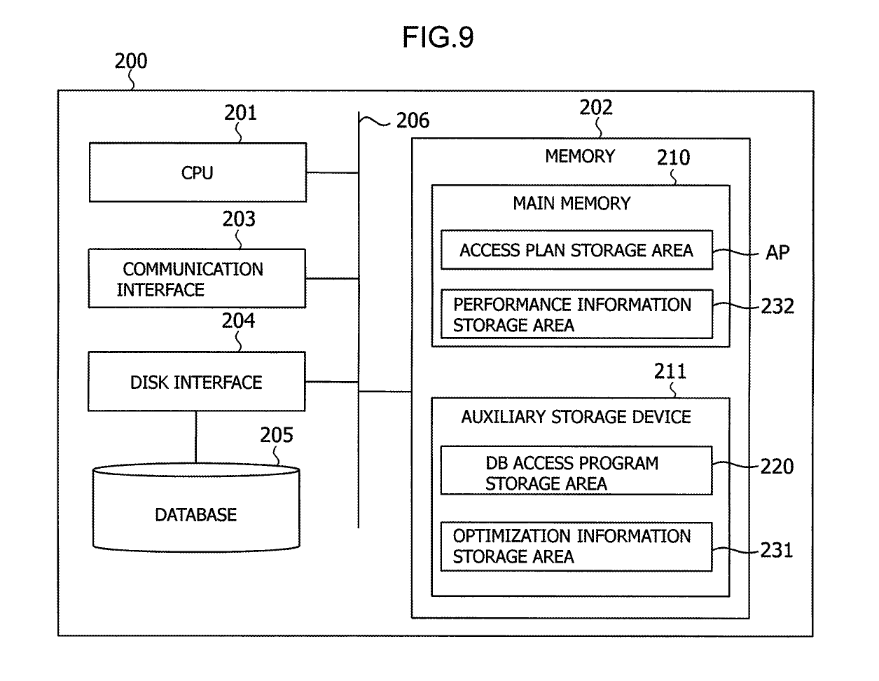

Next, a hardware configuration diagram and a software block diagram of the primary and auxiliary database servers 100 and 200 will be described with reference to FIGS. 9 to 12.

[Hardware Configuration Diagram of Primary Database Server 200]

FIG. 9 is a hardware configuration diagram of the primary database server (the first information processing device) 200 of the present embodiment. The database server 200 includes a central processing unit (CPU) 201, a memory 202 including a main memory 210, an auxiliary storage device 211, and the like, a communication interface 203, a disk interface 204, and a database 205, for example. The respective units are connected to each other via a bus 206.

The CPU 201 is connected to the memory 202 and the like via the bus 206 and controls the entire database server. The communication interface 203 is connected to the auxiliary database server 100 and the application server 300 (FIG. 1) and transmits and receives data.

The main memory 210 which is a random access memory (RAM) or the like stores data and the like processed by the CPU 201. The main memory 210 has an access plan storage area AP and a performance information storage area 232.

An access plan (hereinafter referred to as an access plan AP) of the access plan storage area AP indicates an access plan AP of a SQL command sq in execution. The details of the access plan AP are as illustrated in FIG. 3. The performance information (hereinafter referred to as performance information 232) of the performance information storage area 232 indicates information on the performance of access to the database 205.

The auxiliary storage device 211 has an area (not illustrated) that stores the program of an operating system executed by the CPU 201, a DB access program storage area 220, an optimization information storage area 231, and the like. The auxiliary storage device 211 is a hard disk drive (HDD), a nonvolatile semiconductor memory, or the like.

A DB access program (hereinafter referred to as a DB access program 220) of the DB access program storage area 220 realizes the processing of a database management system (DBMS) by execution of the CPU 201. The processing of the DBMS includes the control of access to the database 205, the management of the database 205, and the like, for example.

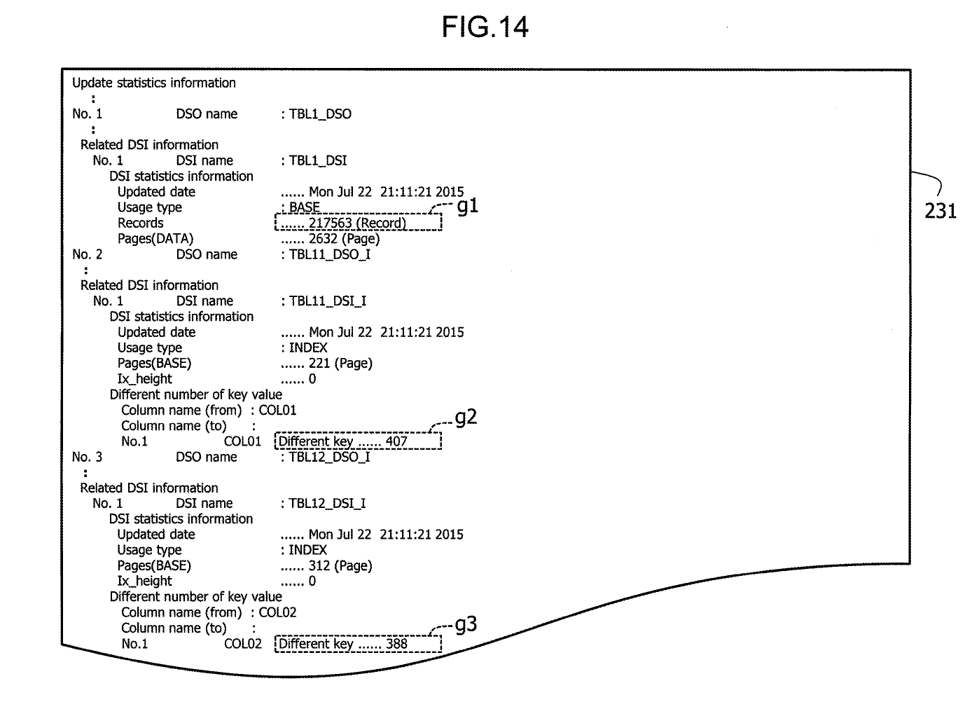

The optimization information (hereinafter referred to as optimization information 231) of the optimization information storage area 231 is information indicating the characteristics of the database 205. The details of the primary optimization information 231 will be described later with reference to FIG. 14.

[Software Block Diagram of Primary System]

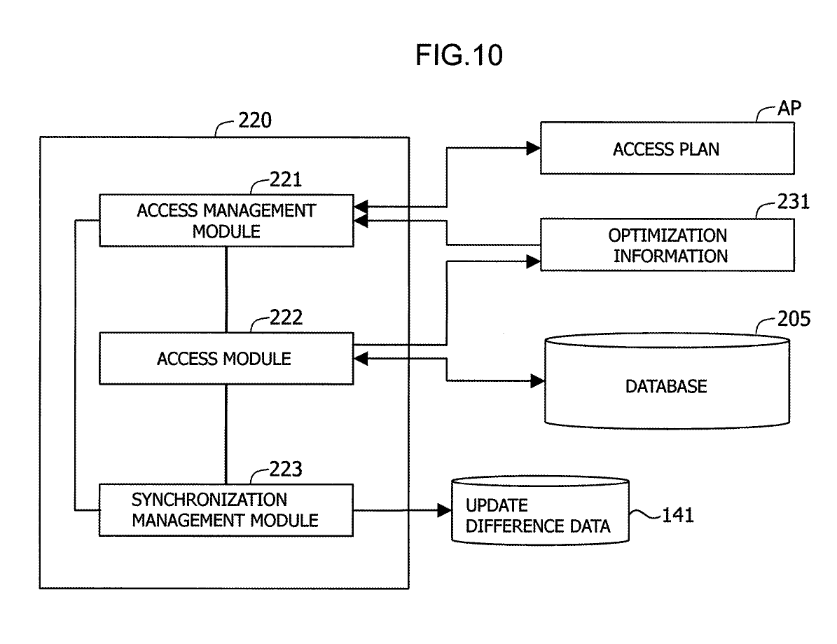

FIG. 10 is a configuration diagram of a software block of the primary database server 200 illustrated in FIG. 9. As illustrated in FIG. 10, the primary DB access program 220 includes an access management module 221, an access module 222, and a synchronization management module 223.

The access management module 221 generates an access plan AP of a SQL command sq according to an instruction (c1 in FIG. 4) received from the application server 300 to generate the access plan AR The access management module 221 generates the access plan AP on the memory 210 based on the SQL command sq and the optimization information 231.

Moreover, when the regenerated access plan APr is received from the auxiliary database server 100, the access management module 221 replaces the access plan AP on the memory 210 with the received access plan APr.

The access module 222 executes the SQL command sq according to the access plan AP to perform access to the database 205. Moreover, the access module 222 updates the optimization information 231 according to an instruction to update the optimization information.

When the database 205 is updated, the synchronization management module 223 generates update difference data 141 indicating the update information of the database 205 and transmits the update difference data 141 to the auxiliary database server 100. Moreover, the synchronization management module 223 transmits the access plan AP and the SQL command sq which is a regeneration target of the access plan AP to the auxiliary database server 100.

[Hardware Configuration Diagram of Auxiliary Database Server 100]

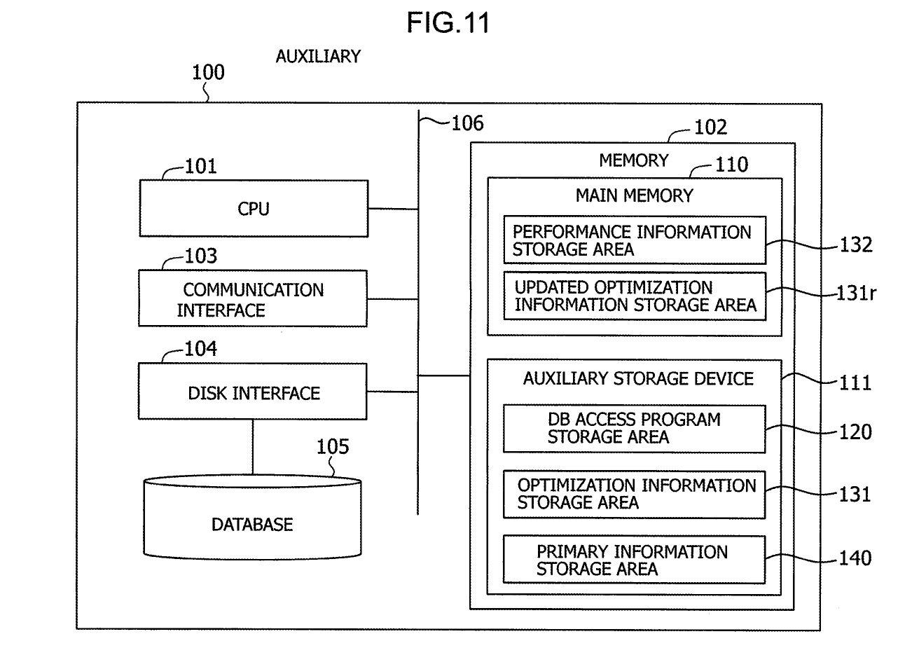

FIG. 11 is a hardware configuration diagram of the auxiliary database server (the second information processing device) 100 of the present embodiment. The database server 100 includes a central processing unit (CPU) 101, a memory 102 including a main memory 110, an auxiliary storage device 111, and the like, a communication interface 103, a disk interface 104, and a database 105, for example. The respective units are connected to each other via a bus 106.

The CPU 101 is connected to the memory 102 and the like via the bus 106 and controls the entire database server. The communication interface 103 is connected to the primary database server 200 and the application server 300 (FIG. 1) and transmits and receives data.

The main memory 110 which is a random access memory (RAM) or the like stores data and the like processed by the CPU 101. The main memory 110 has a performance information storage area 132 and an updated optimization information storage area 131r.

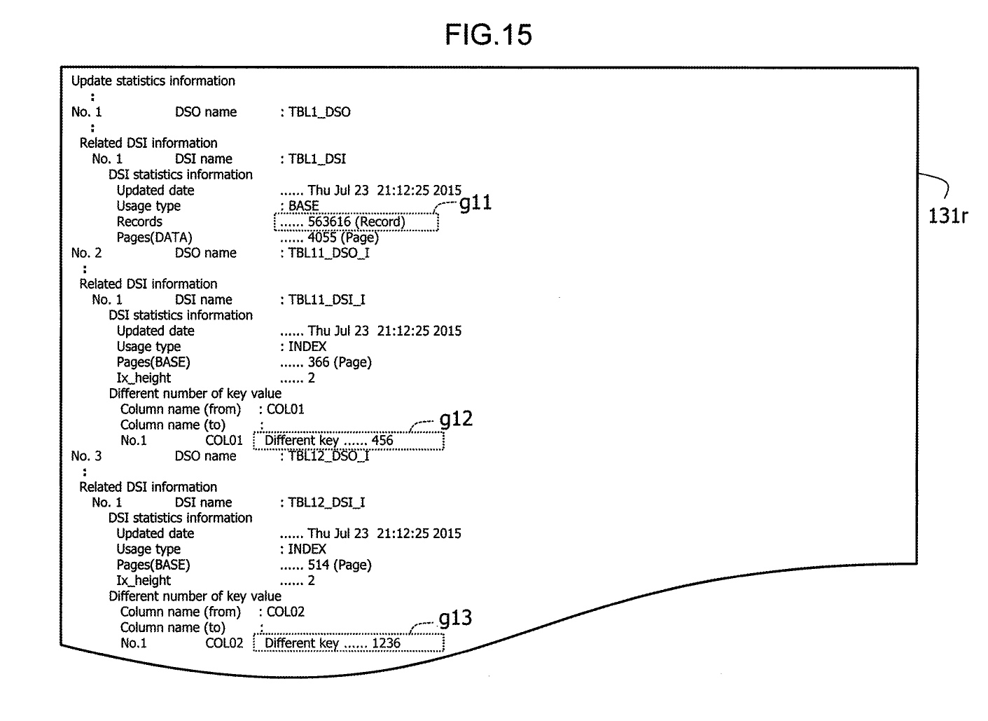

The performance information (hereinafter referred to as performance information 132) of the performance information storage area 132 indicates information on the performance of access to the database 105. The updated optimization information (hereinafter referred to as updated optimization information 131r) of the updated optimization information storage area 131r is information indicating the latest characteristics of the database 105 and indicates information which is referred to in order to regenerate the access plan AP. The details of the updated optimization information 131r will be described later with reference to FIG. 15.

Since the auxiliary database server 100 is a standby server of the primary database server 200, it is needed to maintain the optimization information in the same state as the primary system. Thus, the auxiliary DB access program 120 holds the updated optimization information 131r on the memory 110 separately from the normal optimization information 131.

The auxiliary storage device 111 has an area (not illustrated) that stores the program of an operating system executed by the CPU 101, a DB access program storage area 120, an optimization information storage area 131, a primary information storage area 140, and the like. The auxiliary storage device 111 is a hard disk drive (HDD), a nonvolatile semiconductor memory, or the like.

The DB access program (hereinafter referred to as a DB access program 120) of the DB access program storage area 120 realizes the processing of a DBMS by execution of the CPU 101. The processing of the DBMS includes the control of access to the database 105, the management of the database 105, and the like.

The optimization information (hereinafter referred to as optimization information 131) of the optimization information storage area 131 is information indicating the characteristics of the database 105. Moreover, the optimization information 131 is the normal optimization information of the auxiliary database server 100 and has the same information as the primary optimization information 231.

The primary information (hereinafter referred to as primary information 140) of the primary information storage area 140 indicates the information received from the primary DB access program 220. The primary information 140 includes the update difference data 141, the primary access plan AP generated by the primary DB access program 120, the SQL command sq which is a regeneration target of the access plan AP, and the like, for example. The update difference data 141 is binary data having the update information of the database 205.

[Software Block Diagram of Auxiliary System]

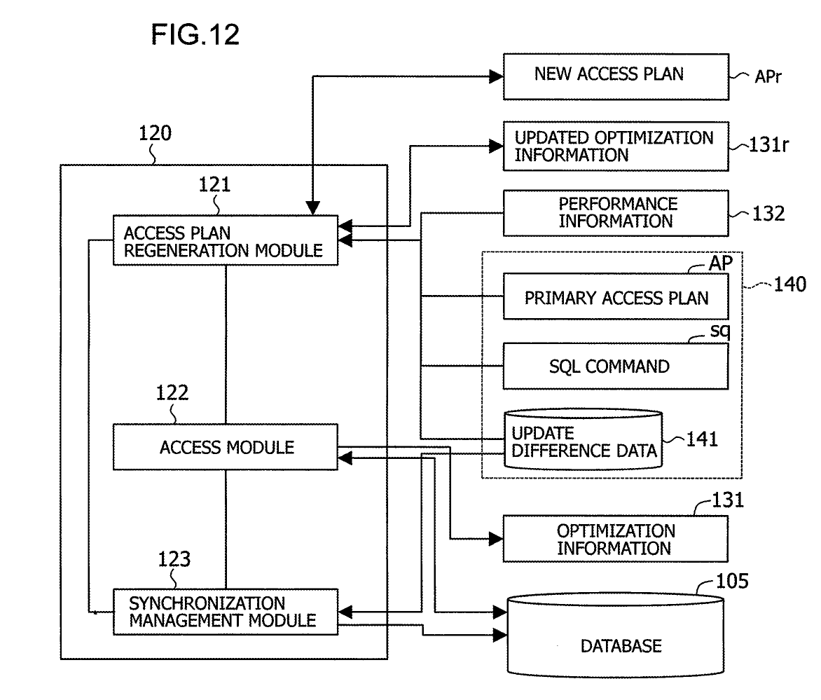

FIG. 12 is a configuration diagram of a software block of the auxiliary database server 100 illustrated in FIG. 11. As illustrated in FIG. 12, the auxiliary DB access program 120 includes an access plan regeneration module 121, an access module 122, and a synchronization management module 123.

The synchronization management module 123 updates the database 105 based on the update difference data 141 of the primary information 140. The access module 122 performs access to the database 105. For example, the access module 122 performs such as referring to of data according to an access request or the like from the application server 300, a user interface, or the like.

Moreover, the access module 122 updates the normal optimization information 131 according to an instruction to update the optimization information.

The access plan regeneration module 121 updates the updated optimization information 131r on the memory 110 based on the update difference data 141. Moreover, the access plan regeneration module 121 generates a new access plan APr based on the SQL command sq of the primary information 140 and the updated optimization information 131r.

When the processing time of the new regenerated access plan APr is shorter than the processing time of the access plan AP of the primary information 140, the access plan regeneration module 121 transmits the access plan APr to the primary database server 200.

Next, the details of the processing of the DBMS of the present embodiment will be described with reference to FIG. 15.

[Process Flow]

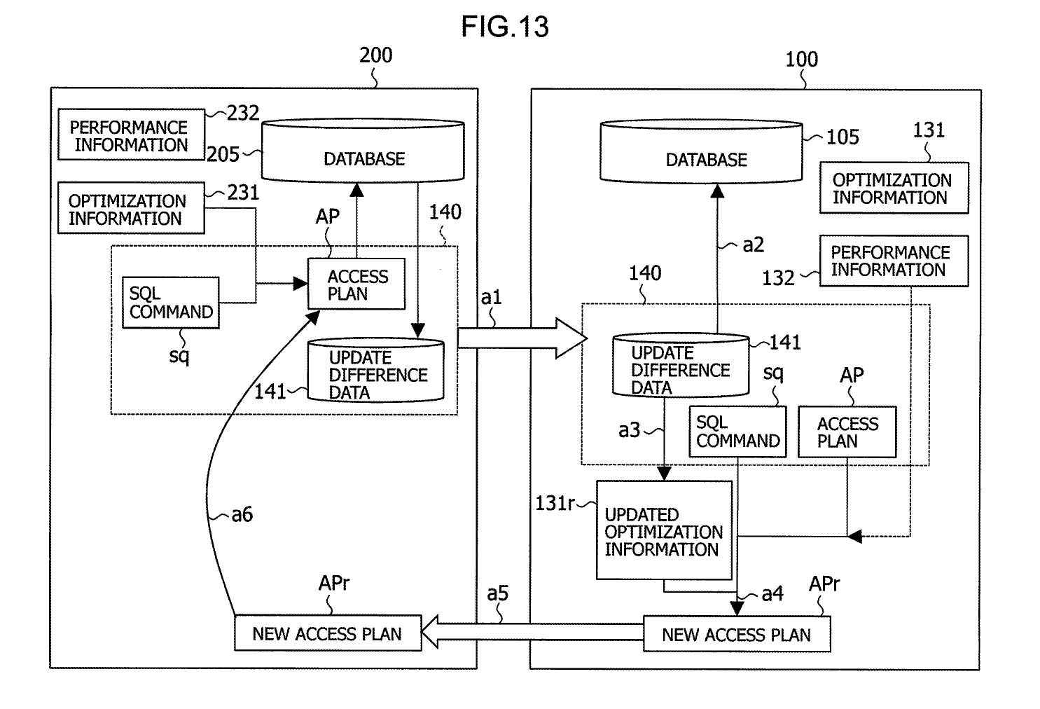

FIG. 13 is a diagram for schematically describing the details of the processes of the DB access program 220 of the primary database server 200 and the DB access program 120 of the auxiliary database server 100 according to the present embodiment.

Similarly to the comparative example illustrated in FIG. 2, the primary DB access program 220 generates an access plan AP based on a SQL command sq and the optimization information 231 according to an access request from the application server 300. Moreover, the primary DB access program 120 executes a SQL command sq according to the generated access plan AP.

(Primary Optimization Information 231)

FIG. 14 is a diagram illustrating an example of the optimization information 231 of the primary database server 200. FIG. 14 illustrates a record count “Records” g1 and a value type count “Different key” g2 and g3 as an example of the optimization information 231. An administrator issues an instruction to update the optimization information 231 in a maintenance period, for example, so as not to influence business processes.

According to the optimization information 231 illustrated in FIG. 14, the number of records of a table “TBL1_DSI” has a value of “217563”. Moreover, the count of value types of an index “TBL11_DSI_I” has a value of “407” and the count of value types of an index “TBL12_DSI_I” has a value of “388”. That is, the count of value types of the index “TBL12_DSI_I” is smaller than that of the index “TBL11_DSI_I”.

Thus, the DB access program 220 generates the access plan AP illustrated in FIG. 3. Returning to FIG. 13, when the SQL command sq is executed, the DB access program 220 generates the update difference data 141. Moreover, the DB access program 220 transmits the update difference data 141, the SQL command sq which is a regeneration target of the access plan AP, and the access plan AP to the auxiliary database server 100 (a1).

Upon receiving the update difference data 141, the auxiliary DB access program 120 updates the auxiliary database 105 based on the update difference data 141 (a2). In this way, the auxiliary database 105 is updated to the same state as the primary database 205. Moreover, the auxiliary DB access program 120 updates the updated optimization information 131r maintained on the memory 110 based on the received update difference data 141 (a3).

As described above, the updated optimization information 131r is different from the normal optimization information 131 of the auxiliary database 105. The updated optimization information 131r is based on the latest state of the auxiliary database 105 whereas the normal optimization information 131 is maintained in the same state as the primary optimization information 231.

(Updated Optimization Information 131r)

FIG. 15 is a diagram illustrating an example of the updated optimization information 131r. In the updated optimization information 131r illustrated in FIG. 15, the record count g11 of the table “TBL1_DSI” is increased to the value “563613” as compared to the optimization information 231 illustrated in FIG. 14. Moreover, the value type count g12 of the index “TBL11_DSI_I” is increased from the value “407” to the value “456” and the value type count g13 of the index “TBL12_DSI_I” is increased from the value “388” to the value “1236” as compared to the optimization information 231 illustrated in FIG. 14.

According to the updated optimization information 131r illustrated in FIG. 15, the value type count g13 of the index “TBL12_DSO_I” is larger than the value type count g12 of the index “TBL11_DSO_I”. This indicates that as the result of access to the database, the value type of the item “COL01” is more distributed than the item “COL01” as compared to the optimization information 231 illustrated in FIG. 14.

In this manner, the primary database server 200 transmits difference information (the update difference data 141) of the primary database 205 generated in response to a SQL command sq (query) to the auxiliary database server 100. Moreover, the auxiliary database server 100 updates the auxiliary database 105 and the updated optimization information 131r (the first information) based on the received difference information (the update difference data 141).

Since the updated optimization information 131r is updated based on the update difference data 141, the auxiliary database server 100 can update the updated optimization information 131r easily without scanning a group of records. Thus, the auxiliary database server 100 can update the updated optimization information 131r to the actual latest state based on the auxiliary database 105 efficiently without increasing the load.

Returning to FIG. 13, when the rate of change in the data of the database 105 in a predetermined period exceeds a reference value, the auxiliary DB access program 120 generates a new access plan APr of the SQL command sq based on the updated optimization information 131r illustrated in FIG. 15 (a4). That is, the auxiliary database server 100 regenerates the access plan AP when the rate of change in the data of the auxiliary database 105 exceeds a reference value.

When the rate of change in the data in a predetermined period exceeds a reference value, since the updated optimization information 231r changes greatly, the access path is highly likely to change. Thus, the auxiliary DB access program 120 can regenerate the access plan AP appropriately at the point in time at which an optimal access path is likely to change by regenerating the access plan AP when the rate of change in the data exceeds a reference value.

Moreover, the auxiliary DB access program 120 generates the access plan AP of the SQL command sq according to a priority order determined based on the rate of change in the data, the number of executions, or the like rather than the order of reception of SQL commands sq.

A SQL command sq of which the number of executions is large provides a high degree of improvement in the processing time due to the large number of executions. Moreover, the optimal access path of a SQL command sq to access a table in which the rate of change in the data is highly likely to change since the updated optimization information 231r changes greatly.

On the other hand, when the access plan AP is regenerated in the order of reception of the SQL commands sq, the regeneration of the access plan AP of the SQL command sq which provides a high improvement effect may be delayed. Thus, when a plurality of items of regeneration target execution plan information (access plans AP) are present, the auxiliary database server 100 determines the priority order of a query. The auxiliary database server 100 determines the priority order of a query based on any one or both of the rate of change in the data of the auxiliary database 105 accessed by the SQL command sq (query) and the number of executions of the query.

Moreover, the auxiliary database server 100 preferentially regenerate the execution plan information (the access plan AP) having a high priority order. In this way, it is possible to preferentially optimize the access plan AP of the SQL command sq which provides a high degree of improvement to access the primary database 105 more efficiently.

Subsequently, when the processing time of the regenerated access plan APr is shorter than the processing time of the primary access plan AP, the auxiliary DB access program 120 transmits the regenerated access plan APr to the primary DB access program 120 (a5). The processing time of the SQL command sq may change due to an influence such as an environmental factor or the performance information 132 in addition to the updated optimization information 131r. Thus, the processing time of the regenerated access plan APr is not always reduced from that of the access plan AP before regeneration.

Thus, the primary database server 200 further transmits regeneration target execution plan information (access plan AP) to the auxiliary database server 100. Moreover, when the time (processing time) needed for access based on the regenerated access plan APr is shorter than the processing time based on the received access plan AP, the auxiliary database server 100 transmits the access plan APr to the primary database server 200.

That is, even when the access plan AP is regenerated, if the processing time based on the access plan AP received from the primary database server 200 is the shortest, the auxiliary database server 100 does not transmit the regenerated access plan APr. In this way, the primary DB access program 220 can acquire the optimal access plan AP only which reduces the processing time and can eliminate an unneeded communication process.

When the access plan APr is received, the primary DB access program 120 overwrites the received access plan APr to the access plan AP held therein (a6) and executes the SQL command sq according to the updated access plan APr. That is, the primary database server 200 executes the SQL command sq (query) based on the access plan AP received from the auxiliary database server 100.

In this way, the primary database server 200 can reduce the processing time by executing the SQL command sq according to the optimal access plan APr based on the updated optimization information 131r which reflects the actual auxiliary database 105.

In this manner, the database system of the present embodiment updates the updated optimization information 131r maintained on the memory 110 based on the update difference data 141 when applying the update difference data 141. In this way, the auxiliary DB access program 120 can generate the optimal access plan APr based on the updated optimization information 131r which is based on the state of the database 105. Moreover, the auxiliary normal optimization information 131 of the auxiliary is maintained in the same state as the primary optimization information 231.

Moreover, the primary database server 200 can generate an access plan AP which suppresses a computer processing load and perform access to the database 205 more efficiently since the optimization information 231 is not updated. In this way, it is possible to perform the business processes of the primary system by using the auxiliary database server 100 of the mirroring system while appropriately managing the mirroring system.

[Performance Information 132]

FIG. 13 illustrates a case in which the auxiliary DB access program 120 generates the access plan APr based on the SQL command sq and the updated optimization information 131r. The auxiliary database server 100 may regenerate the access plan AP based on second information (performance information 132) on the performance of access to the auxiliary database 105 in addition to the first information (the updated optimization information 131r) and the query (the SQL command sq).

The performance information 132 indicates information on the performance of access to a database. The performance information 132 indicates the number of I/Os of the access to the auxiliary database 105, the I/O time of the access, the use time of a processor when executing a query, and the like, for example. Moreover, the performance information 132 indicates a hit rate in a shared disk, of a target record group accessed by a query (SQL command sq), the number of records of each access, accessed by the query, and the like. The performance information 132 may be any one or a combination of the above-mentioned items of information.

For example, when an access program of a SQL command sq that indicates a table join (JOIN), the DB access program 120 selects a row join method according to the number of records and generates the access plan AP. Specifically, for example, when the number of records exceeds a predetermined value, the DB access program 120 switches a join method of the access plan AP from method “FETCH JOIN” to method “MERGE_JOIN”:

However, when the access plan AP is regenerated based on the updated optimization information 131r only, the processing time may increase due to the switching to method “MERGE_JOIN”. Specifically, when the I/O performance of a join target table is high (that is, the I/O processing time is short), the processing time of the SQL command sq may increase.

Thus, the auxiliary DB access program 120 can further generate a generally appropriate access plan AP as the program is based on the performance information 132. In this way, it is possible to further reduce the processing time of the SQL command sq. The details of the process will be described later with reference to FIG. 22.

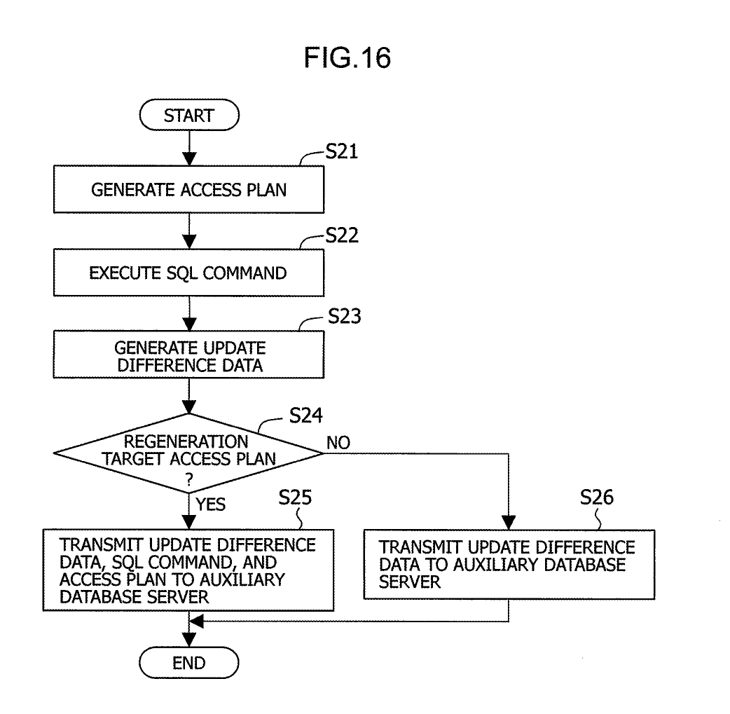

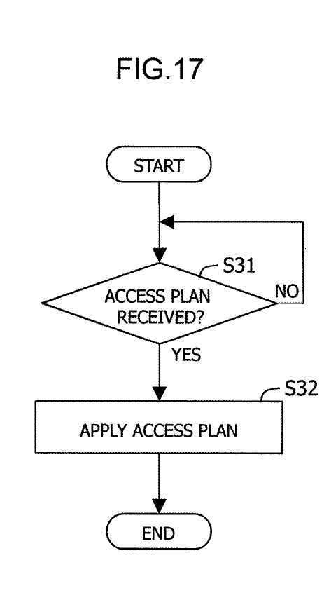

Next, the details of the process of the DB access program 220 of the primary database server 200 will be described with reference to the flowcharts of FIGS. 16 and 17.

[Process Flow of Primary DB Access Program 220]

FIG. 16 is a diagram for describing the flow of a process of the primary DB access program 220 instructing regeneration of the access plan AP.

In step S21, the access management module 221 of the primary DB access program 220 generates an access plan AP of a SQL command sq in response to an instruction to execute the SQL command sq. The access management module 221 generates the access plan AP illustrated in FIG. 3 based on the SQL command sq and the optimization information 231.

In step S22, the access module 222 executes the SQL command sq according to the generated access plan AR For example, when the SQL command sq is executed a predetermined number of times, the SQL command sq is executed once and the flow proceeds to step S23.

In step S23, the synchronization management module 223 generates the update difference data 141 based on the databases before and after updating. The update difference data 141 is binary data indicating the updated content of a record, for example.

In step S24, the access management module 221 determines whether the access plan AP of the executed SQL command sq is a regeneration target access plan AP. For example, when the SQL command sq indicates deletion of all records in a table, adding of a record, and the like, a plurality of access paths rarely occur. Thus, the access management module 221 does not use the access plan AP of the SQL command sq indicating deletion of all records, adding of a record, and the like, for example, as a regeneration target.

In step S25, when the access plan AP is a regeneration target (S24: Yes), the access management module 221 transmits the update difference data 141, the SQL command sq, and the access plan AP to the auxiliary DB access program 120.

In step S26, when the access plan AP is not the regeneration target (S24: No), the access management module 221 transmits the update difference data 141 to the auxiliary DB access program 120.

FIG. 17 is a diagram for describing the flow of a process of the primary DB access program 220 receiving the access plan AP regenerated by the auxiliary access program.

In step S31, the access management module 221 determines whether the regenerated access plan APr has been received from the auxiliary access program.

In step S32, when the access plan APr has been received (S31: Yes), the access management module 221 updates the received access plan APr to the access plan AP in execution. Moreover, the access management module 221 executes the SQL command sq a remaining number of times according to the updated access plan APr. In this way, the primary DB access program 220 can reduce the processing time of the SQL command sq.

[Process Flow of Auxiliary DB Access Program 120]

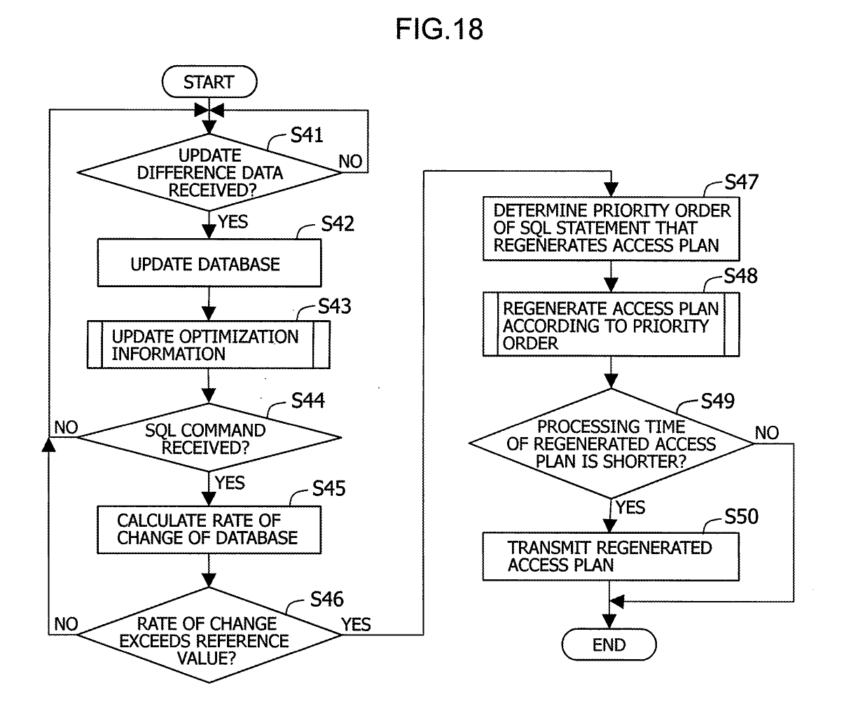

Next, the details of the process of the DB access program 120 of the auxiliary database server 100 will be described with reference to the flowcharts of FIGS. 18 to 22.

FIG. 18 is a flowchart for describing a process of the auxiliary DB access program 120 regenerating the access plan AP.

In step S41, the synchronization management module 123 determines whether the update difference data 141 has been received.

In step S42, when the update difference data 141 has been received (S41: Yes), the synchronization management module 123 updates the auxiliary database 105 based on the update difference data 141.

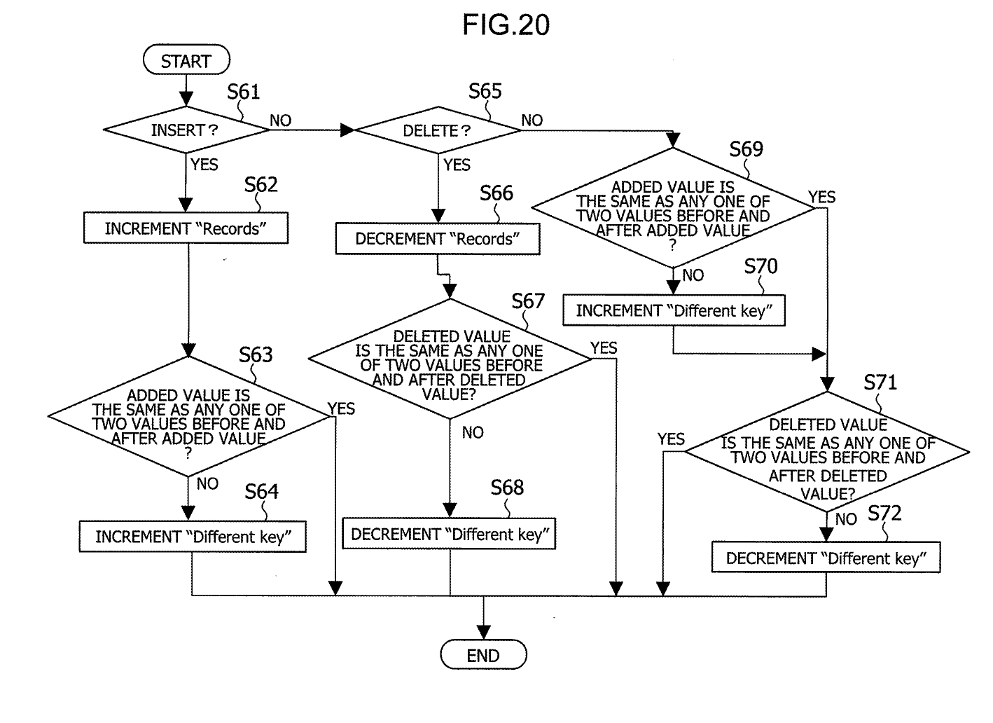

In step S43, the access plan regeneration module 121 updates the updated optimization information 131r held on the memory 110 based on the update difference data 141. The details of the process of step S43 will be described later with reference to FIG. 20.

In step S44, the access plan regeneration module 121 determines whether the SQL command sq which is a regeneration target of the access plan AP and the access plan AP of the SQL command sq in addition to the update difference data 141 have been received.

In step S45, when the SQL command sq and the primary access plan AP have been received (S44: Yes), the access plan regeneration module 121 calculates the rate of change in the data in a predetermined period, of the database 105 which is an access target of the SQL command sq. For example, the access plan regeneration module 121 calculates the rate of change based on the ratio of the number of updated records to a total number of records.

In step S46, the access plan regeneration module 121 determines whether the rate of change calculated in step S45 exceeds a reference value. The reference value is 20%, for example. However, the reference value is not limited to this example, but the reference value is determined based on tests or the like.

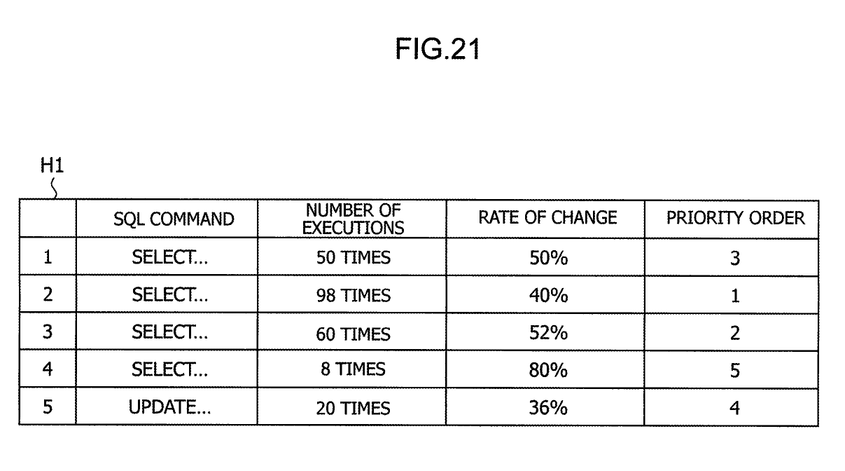

In step S47, when the rate of change exceeds the reference value (S46: Yes), if a plurality of SQL commands sq which are regeneration targets of the access plan AP are present, the access plan regeneration module 121 determines the priority order of the SQL command sq that regenerates the access plan AP. The priority order of the SQL command sq will be described in detail with reference to FIG. 21.

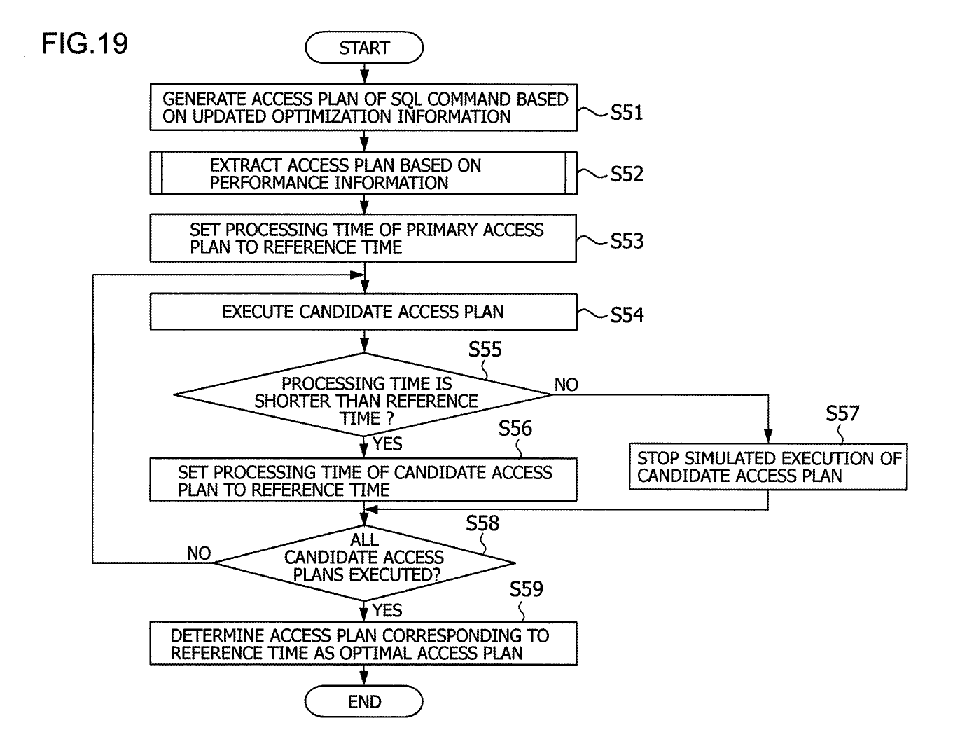

In step S48, the access plan regeneration module 121 regenerates the access plans AP sequentially according to the priority order determined in step S47. The details of the process of regenerating the access plan AP will be described with reference to FIG. 19.

In step S49, the access plan regeneration module 121 determines whether the processing time of the regenerated access plan APr is shorter than the processing time of the primary access plan AP.

In step S50, when the processing time of the access plan APr is shorter (S49: Yes), the access plan regeneration module 121 transmits the regenerated access plan APr to the primary DB access program 220.

On the other hand, when the processing time of the access plan APr is longer (S49: No), the access plan regeneration module 121 does not transmit the regenerated access plan APr to the primary DB access program 220. In this way, it is possible to eliminate an unneeded communication process.

[S48 in FIG. 18: Access Plan AP Regeneration Process]

FIG. 19 is a flowchart for describing the details of the process of step S48 in the flowchart of FIG. 18. In step S48, the access plan regeneration module 121 regenerates the access plan AP of the SQL command sq.

In step S51, the access plan regeneration module 121 generates a plurality of access plans AP of the SQL command sq based on the updated optimization information 131r. For example, the access plan regeneration module 121 generates a plurality of access plans AP of which the processing time falls within a predetermined range.

In step S52, the access plan regeneration module 121 extracts an access plan AP based on the performance information 132 from the plurality of access plans AP generated in step S51 as a candidate access plan AR The details of the process of step S52 will be described later with reference to FIG. 22.

In step S53, the access plan regeneration module 121 sets the processing time of the primary access plan AP to a reference time.

In step S54, the access plan regeneration module 121 selects the candidate access plan AP, executes the SQL command sq according to the selected candidate access plan AP simulatively, and acquire the processing time. That is, the access plan regeneration module 121 acquires the processing time by simulating the SQL command sq. Since the SQL command sq is executed simulatively, the auxiliary database 105 is not updated.

In step S55, the access plan regeneration module 121 determines whether the processing time of the selected candidate access plan AP is shorter than the set reference time.

In step S56, when the processing time of the candidate access plan AP is shorter (S55: Yes), the access plan regeneration module 121 sets the processing time of the selected candidate access plan AP to the reference time.

In step S57, when the processing time of the candidate access plan AP is longer (S55: No), the access plan regeneration module 121 stops the simulative execution of the candidate access plan AP.

In step S58, the access plan regeneration module 121 determines whether all extracted candidate access plans AP have been executed.

In step S59, when all candidate access plans AP have been executed (S58: Yes), the access plan regeneration module 121 determines an access plan AP corresponding to the reference time as an optimal access plan AP. That is, the access plan regeneration module 121 determines an access plan AP of which the processing time is shortest.

On the other hand, when there is a candidate access plan AP which has not been executed (S58: No), the access plan regeneration module 121 proceeds to the process of step S54 and selects another candidate access plan AP.

Some SQL commands sq include a sub query. Different SQL commands sq may include a common sub query. Thus, the access plan regeneration module 121 may acquire and manage the processing time for respective sub queries.

In this manner, when calculating the processing time of SQL commands sq which include the same sub query, the processing time of the sub query held therein can be reused. In this way, the access plan regeneration module 121 can calculate the processing time of the SQL command sq which includes the sub query more easily.

[S43 in FIG. 18: Updated Optimization Information 131r Updating Process]

FIG. 20 is a flowchart for describing the flow of the process of step S43 in the flowchart of FIG. 18. The access plan regeneration module 121 updates the updated optimization information 131r held on the memory based on the update difference data 141 as the process of step S43. As illustrated in FIGS. 14 and 15, the updated optimization information 131r of the present embodiment includes a record count “Records” and a value type count “Different key”.

In step S61, the access plan regeneration module 121 determines whether the update difference data 141 indicates adding “INSERT” of data.

In step S62, when the update difference data 141 indicates adding “INSERT” of data (S61: Yes), the access plan regeneration module 121 increments the record count “Records” of an addition target table.

In step 63, the access plan regeneration module 121 determines whether the added value is the same as any one of the two values before and after the added value, in the index of the addition target table.

In step S64, when the added value is different from both of the two values before and after the added value (S63: No), the access plan regeneration module 121 increments the value type count“Different key”. On the other hand, when the added value is the same as any one of the two values (S63: Yes), the access plan regeneration module 121 does not update the value type count “Different key”.

In step S65, when the update difference data 141 does not indicate adding “INSERT” of data (S61: No), the access plan regeneration module 121 determines whether the update difference data 141 indicates deletion “DELETE” of data.

In step S66, when the update difference data 144 indicates deletion “DELETE” of data (S65: Yes), the access plan regeneration module 121 decrements the record count “Records” in the deletion target table.

In step S67, the access plan regeneration module 121 determines whether the deleted value is the same as any one of the two values before and after the deleted value in the index of the deletion target table.

In step S68, when the deleted value is different from both of the two values before and after the deleted value (S67: No), the access plan regeneration module 121 decrements the value type count“Different key”. On the other hand, when the deleted value is the same as any one of the two values before and after the deleted value (S67: Yes), the access plan regeneration module 121 does not update the value type count “Different key”.

In step S69, when the update difference data 141 does not indicate deletion (DELETE) of data (S65: No), the access plan regeneration module 121 determines whether the value added by the update process is the same as any one of the two values before and after the added value, in the index of the update target table.

In step S70, when the added value is different from both of the two values before and after the added value (S69: No), the access plan regeneration module 121 increments the value type count “Different key”.

In step S71, the access plan regeneration module 121 determines whether the value deleted by the update process is the same as any one of the two values before and after the deleted value, in the index of the update target table.

In step S72, when the deleted value is different from both of the two values before and after the deleted value (S71: No), the access plan regeneration module 121 decrements the value type count “Different key”.

In this manner, the auxiliary DB access program 120 of the present embodiment can update the updated optimization information 131r easily based on the update difference data 141 without scanning the records of the auxiliary database 105 one by one. In this way, the auxiliary DB access program 120 can update the updated optimization information 131r efficiently without adding a load to the auxiliary database server 100. Therefore, the DB access program 120 can generate the access plan APr timely.

[Order of SQL Command Sq to Regenerate Access Plan AP]

FIG. 21 is a diagram for describing the priority order of a SQL command sq that regenerates an access plan AP. A table H1 illustrated in FIG. 21 has information including a SQL command sq which is a regeneration target of the access plan AP, the number of executions of the SQL command sq, the rate of change in the data of an access target table of the SQL command sq, and the priority order of regeneration of the access plan AP.

The access plan regeneration module 121 determines the priority order of regeneration of the access plan AP according to any one or both of the number of executions of the SQL command sq and the rate of change in data. The rate of change in data indicates the rate of change in a predetermined period, for example.

In the present embodiment, the priority order of a first query (SQL command sq) to access a first data group is higher than the priority order of a second query (SQL command sq) to access a second data group of which the rate of change is lower than the first data group. As described above, the access path of the access plan AP of the SQL command sq that accesses a table in which the rate of change in data is high is highly likely to change with regeneration and provides a high improvement effect.

Thus, the access plan regeneration module 121 can reduce the processing time of the access to the primary database 205 more effectively by preferentially regenerating the access plan AP of the SQL command sq that accesses a data group of which the rate of change in data is high.

Moreover, according to the access plan regeneration module 121 of the present embodiment, the priority order of a third query (SQL command sq) is higher than a fourth query (SQL command sq) of which the number of executions is smaller than the third query. As described above, the access plan AP of the SQL command sq of which the number of executions is large provides a high improvement effect when the access plan AP is regenerated. Thus, the access plan regeneration module 121 can reduce the response time of access to the primary database 205 more effectively by preferentially regenerating the access plan AP of the SQL command sq of which the number of executions is large.

According to the table illustrated in FIG. 21, the number of executions of a SQL command sq (SELECT) on row number “2” is “98” and the rate of change in data is “40%”. Moreover, the number of executions of a SQL command sq (SELECT) on row number “3” is “60” and the rate of change in data is “52%”.

Although the rate of change in data caused by the SQL command sq on row number “2” is smaller than that of the SQL command sq on row number “3”, the number of executions of the SQL command sq on row number “2” is greatly larger than that of the SQL command sq on row number “3”. Thus, the access plan regeneration module 121 determines the SQL command sq on row number “2” from a plurality of SQL commands sq illustrated in FIG. 21 as a SQL command sq that regenerates the access plan AP on the highest priority.

Moreover, the access plan regeneration module 121 determines the SQL command sq on row number “3” as the SQL command sq that regenerates the access plan AP on the next highest priority. Similarly, the access plan regeneration module 121 determines the priority order of each SQL command sq based on the number of executions and the rate of change.

FIG. 21 illustrates a case in which the priority order is determined based on the number of executions of the SQL command sq and the rate of change in data. However, the present invention is not limited to this example, but the priority order may be determined based on any one of the number of executions and the rate of change in data.

[S52 in FIG. 19: Extraction of Access Plan AP Based on Performance Information 132]

FIG. 22 is a flowchart for describing the details of the process of step S52 in the flowchart of FIG. 19. The access plan regeneration module 121 extracts an access plan AP from a plurality of access plans AP based on the performance information 132 as a candidate access plan AP.

In step S81, the access plan regeneration module 121 calculates the processing time of each access plan AP based on an I/O count, an I/O processing time, a CPU usage rate, a hit rate of a shared disk, the number of records to be accessed, and the like, for example.

An access target table and an index are different depending on an access plan AP. Since the performance information 132 is different depending on a table and an index, the processing time may change. Thus, the access plan regeneration module 121 extracts the access plan AP based on the performance information 132 in addition to the updated optimization information 131r. In this way, the access plan regeneration module 121 can generate a more optimal access plan AP, with an access performance based on an environment or the like being taking into consideration.

The hardware specification of the auxiliary database server 100 is the same as the hardware specification of the primary database server 200. Thus, the access plan regeneration module 121 can use the performance information 132 of the auxiliary database server 100.

Moreover, the access plan regeneration module 121 can acquire the performance information 132 by using a command of an operating system, an application programming interface (API), and the like, for example. Alternatively, the access plan regeneration module 121 may further acquire the performance information 232 of the primary database server 200.

Specifically, the hit rate of a shared disk indicates the hit rate in a shared disk (shared memory or the like), of an accessed page when a SQL command sq is executed according to an access plan AR Moreover, the I/O count indicates the number of I/Os of a file when the SQL command sq is executed according to the access plan AP.

The I/O processing time indicates the time needed for the I/O of an access target table when the SQL command sq is executed according to the access plan AP. A physical disk that stores a table may be different depending on the table. The I/O processing time is different depending on a physical disk. Moreover, the CPU use time indicates the CPU use time when the SQL command sq is executed according to the access plan AP.

Moreover, the number of records to be accessed indicates information h1 to h12 of the item “access (read/ins/del/upd)” of the trace information TR1 and TR2 illustrated in FIGS. 14 and 15. The processing time decreases when the number of records to be accessed is decreased.

The access plan regeneration module 121 calculates the processing time by referring to the performance information 132 when the access plan AP is applied. Depending on the performance information 132, the processing time has a trade-off relation between different items of performance information 132. For example, some access plan AP may have a small I/O count and a long CPU use time. Thus, the access plan regeneration module 121 calculates the processing time of the access plan AP based on a combination of a plurality of items of performance information 132, for example.

In step 82, the access plan regeneration module 121 extracts an access plan AP of which the calculated processing time is shorter than the processing time of the primary access plan AP as a candidate access plan AP.

### Other Embodiment

In the present embodiment, a case in which the SQL command sq is executed simulatively to acquire the processing time when regenerating the access plan AP has been illustrated. However, the present invention is not limited to this example. The DB access program 120 may acquire the processing time of the SQL command sq according to a processing time calculation process.

An information processing device comprising a processor that executes a process including receiving a query corresponding to regeneration target execution plan information among items of execution plan information for access to a first database from a first information processing device, updating first information indicating characteristics of a second database that is a standby system of the first database, in response to updating of data of the second database, regenerating the regeneration target execution plan information, based on the first information and the query, and transmitting the regenerated execution plan information to the first information processing device.

The information processing device, wherein the receiving difference information of the first database generated in response to execution of the query, and the updating updates the second database and the first information, based on the received difference information.

The information processing device, wherein when there are a plurality of items of regeneration target execution plan information, the regenerating determines a priority order of the query, based on any one or both of a rate of change in data of the second database accessed by the query and the number of executions of the query and preferentially regenerates the execution plan information having a high priority order.

The information processing device, wherein the regenerating regenerates the regeneration target execution plan information when the rate of change in data of the second database exceeds a reference value.

The information processing device, wherein the regenerating regenerates the regeneration target execution plan information, based on second information on performance of access to the second database in addition to the first information and the query.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A database system comprising:
a first information processing device that accesses a first database; and
a second information processing device that accesses a second database that is a standby system of the first database, wherein
the first information processing device includes a processor that executes a process including transmitting to the second information processing device a query corresponding to regeneration target execution plan information among items of execution plan information for access to the first database, and
the second information processing device includes a processor that executes a process including:
updating first information indicating characteristics of the second database in response to updating of data of the second database;
regenerating the regeneration target execution plan information, based on the first information and the query; and
transmitting the regenerated execution plan information to the first information processing device.

2. The database system according to claim 1, wherein
the transmitting of the first information processing device transmits to the second information processing device difference information of the first database generated in response to execution of the query, and
the updating updates the second database and the first information, based on the received difference information.

3. The database system according to claim 1, wherein
the processor of the first information processing device further includes executing the query, based on the execution plan information received from the second information processing device.

4. The database system according to claim 1, wherein
when there are a plurality of items of regeneration target execution plan information, the regenerating determines a priority order of the query, based on any one or both of a rate of change in data of the second database accessed by the query and the number of executions of the query and preferentially regenerates the execution plan information having a high priority order.

5. The database system according to claim 4, wherein
the priority order of a first query that accesses a first data group is higher than the priority order of a second query that accesses a second data group, the rate of change of which is lower than that of the first data group.

6. The database system according to claim 4, wherein
the priority order of a third query is higher than a fourth query, the number of executions of which is smaller than that of the third query.

7. The database system according to claim 1, wherein
the transmitting of the first information processing device further transmits the regeneration target execution plan information to the second information processing device, and
when a time needed for executing the query based on the regenerated execution plan information is shorter than a time needed for executing the query based on the regeneration target execution plan information received from the first information processing device, the transmitting of the second information processing device transmits the regenerated execution plan information to the first information processing device.

8. The database system according to claim 1, wherein
the regenerating regenerates the regeneration target execution plan information when the rate of change in data of the second database exceeds a reference value.

9. The database system according to claim 1, wherein
the regenerating regenerates the regeneration target execution plan information, based on second information on performance of access to the second database in addition to the first information and the query.

10. The database system according to claim 1, wherein
the first information indicates any one or both of the number of value types of predetermined items of the second database and the number of records of the second database.

11. The database system according to claim 9, wherein
the second information indicates any one or a combination of the number of I/Os of access to the second database, an I/O time of the access, a use time of the processor when the query is executed, a hit rate in a shared disk of a group of records accessed by the query, and the number of records of accesses by the query.

12. A database access method comprising:
operating a first information processing device to transmit to a second information processing device that accesses a second database that is a standby system of a first database, a query corresponding to regeneration target execution plan information among items of execution plan information for access to the first database, and
operating the second information processing device to update first information indicating characteristics of the second database in response to updating of data of the second database, regenerate the regeneration target execution plan information, based on the first information and the query, and transmit the regenerated execution plan information to the first information processing device.

13. The database access method according to claim 12, wherein
the first information processing device transmits to the second information processing device difference information of the first database generated in response to execution of the query, and
the second information processing device updates the second database and the first information, based on the received difference information.

14. The database access method according to claim 12, wherein
the first information processing device executes the query, based on the execution plan information received from the second information processing device.

15. The database access method according to claim 12, wherein
when there are a plurality of items of regeneration target execution plan information, the second information processing device determines a priority order of the query, based on any one or both of a rate of change in data of the second database accessed by the query and the number of executions of the query and preferentially regenerates the execution plan information having a high priority order.

16. The database access method according to claim 12, wherein
the second information processing device regenerates the regeneration target execution plan information when the rate of change in data of the second database exceeds a reference value.

17. The database access method according to claim 12, wherein
the second information processing device regenerates the regeneration target execution plan information, based on second information on performance of access to the second database in addition to the first information and the query.

18. A non-transitory computer-readable storage medium storing therein a database access program that causes a computer to execute a process comprising:
receiving a query corresponding to regeneration target execution plan information among items of execution plan information for access to a first database from a first information processing device;
updating first information indicating characteristics of a second database that is a standby system of the first database, in response to updating of data of the second database;
regenerating the regeneration target execution plan information, based on the first information and the query; and
transmitting the regenerated execution plan information to the first information processing device.

19. The storage medium according to claim 18, wherein
the receiving receives difference information of the first database generated in response to execution of the query, and
the updating updates the second database and the first information, based on the received difference information.

20. The storage medium according to claim 18, wherein
when there are a plurality of items of regeneration target execution plan information, the regenerating determines a priority order of the query, based on any one or both of a rate of change in data of the second database accessed by the query and the number of executions of the query and preferentially regenerates the execution plan information having a high priority order.

21. The storage medium according to claim 18, wherein
the regenerating regenerates the regeneration target execution plan information when the rate of change in data of the second database exceeds a reference value.

22. The storage medium according to claim 18, wherein
the regenerating regenerates the regeneration target execution plan information, based on second information on performance of access to the second database in addition to the first information and the query.
